(19) United States
(12) Patent Application Publication
(10) Pub. No.: US 2012/0072411 A1
(43) Pub. Date: Mar. 22, 2012

(54) DATA REPRESENTATION FOR PUSH-BASED QUERIES

(75) Inventors: Bart De Smet, Bellevue, WA (US); Henricus Johannes Maria Meijer, Mercer Island, WA (US)

(73) Assignee: MICROSOFT CORPORATION, Redmond, WA (US)

(21) Appl. No.: 12/884,158

(22) Filed: Sep. 16, 2010

(51) Int. Cl. G06F 17/30

(52) U.S. Cl. 707/713; 707/769; 707/759; 707/E17.017

(57) ABSTRACT

A query over one or more push-based data sources is transformed into a data representation of the query. The data representation can subsequently be analyzed, optimized, and remoted, among other things. For example, the data representation can be utilized to generate code for an out-of-process execution engine. Additionally, the data representation can be employed with respect to conversions to and from various types and representations of data.

### BACKGROUND

Data processing is a fundamental part of computer programming. One can choose from amongst a variety of programming languages with which to author programs. The selected language for a particular application may depend on the application context, a developer's preference, or a company policy, among other things. Regardless of the selected language, a developer will ultimately have to deal with data, namely querying and updating data.

Data can be classified as either pull-based or push-based as function of how the data is acquired. Pull-based data is data that is actively retrieved. For example, a program can iterate over a collection of items in an array to request and retrieve items. Similarly, data can be pulled from a local or remote database. By contrast, push-based data is provided to a program at arbitrary times. A classic example is a user interface that pushes values in response to user input such as mouse movement or item selection. Asynchronous computations can also be viewed as sources of push-based data in light of communication latency, potential errors, or timeouts. For instance, a program can request that a computation be performed on a remote machine and be notified of the result when the computation is complete. However, the exact time that the result of the computation is returned is unknown to the program and can vary based on network latency as well as remote machine processing power and load, among other factors.

Working with pull-based data can be called interactive programming while working with push-based data can be termed reactive programming. In an interactive pull-based program, program code requesting the data is in control and will be blocked until data becomes available. Alternatively, in a reactive push-base program, the environment (e.g., database, web service, UI framework . . . ) is in control and determines when data is delivered to the application. Hence, program code will not be blocked.

Reactive programming (a.k.a. asynchronous or event-based programming) is becoming increasingly prevalent in modern computer applications. In particular, reactive programming is beneficial in the context of multi-core and distributed or cloud computing. In these cases, work can be distributed across two or more cores or computers.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to a data representation for push-based queries. A query can be specified with respect to a push-based data source. Subsequently, a data representation of that query can be produced to facilitate translation, optimization, and remoting of execution, among other things. In accordance with one embodiment, the query can be specified in query expression syntax within a program and an expression tree can be constructed as a function thereof.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a query transformation system.

FIG. 2 is a block diagram of query declaration system.

FIG. 3 is a block diagram of a query transformation system.

FIGS. 4A-B are block diagrams of conversion components.

FIG. 5 is a block diagram of an exemplary data access system.

FIG. 6 is a flow chart diagram of method of query transformation.

FIG. 7 is a flow chart diagram of a method of generating a data representation of a push-based query.

FIG. 8 is a flow chart diagram of method of interacting with a data representation of a push-based query

FIG. 9 is a flow chart diagram of a method of maintaining code parity.

FIG. 10 illustrates a first phase of compilation in which query expression triggers emission of expression trees for lambda expressions due to assignment.

FIG. 11 illustrates a second phase of compilation wherein expression tree stitching is carried out by query operators.

FIG. 12 is a graphical representation of the relationship between four exemplary collection interfaces: IEnumerable<T>, IQueryable<T>, IObservable<T>, and IQbservable<T>.

FIG. 13 is a schematic block diagram illustrating a suitable operating environment for aspects of the subject disclosure.

### DETAILED DESCRIPTION

Details below are generally directed toward push-based queries. A query can be specified over one or more push-based data sources. Subsequently, the query can be captured as data as opposed to code. A data representation can facilitate at least query analysis, optimization, transformation, and/or remoting of execution (e.g., transmitting a query across application domain boundaries). Additionally, a code representation of a query can be utilized to produce a data representation, and data representation of a query can be employed to produce a code representation. Furthermore, a data representation of a query over a pull-based data source can be used to generate a data representation over a push-based data source and vice versa.

In accordance with one embodiment, a push-based query can be specified as a query expression, which is a shorthand query syntax currently utilized to interact with various types of data. Use of query expression syntax is beneficial at least because programmers need not learn a different query language to interact with push-based data as disclosed but rather can utilize a familiar syntax that can be mapped to appropriate functionality behind the scenes. From the query expression, an expression tree can be constructed that captures a push-based query as data rather than code. Furthermore, the expression tree can potentially include one or more n-ary operators and/or complex join patterns, which may warrant expansion into a domain specific expression form. Overall, everything that allows expressing push-based data analysis from one or more sources can be captured in a data representation.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

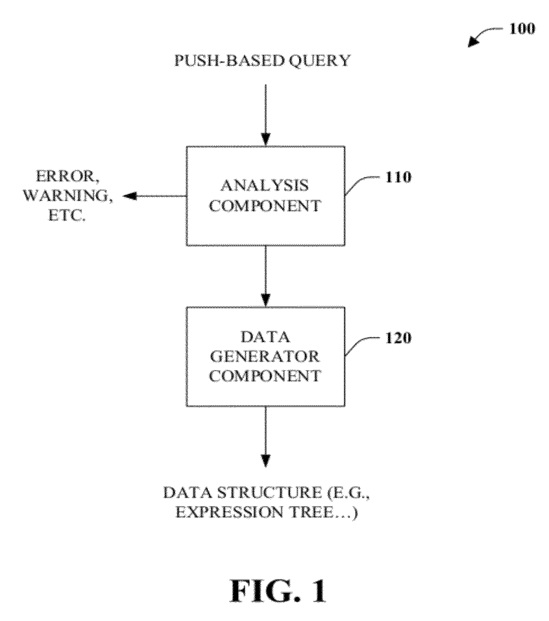

Referring initially to FIG. 1, a query transformation system 100 is illustrated. The query transformation system 100 includes an analysis component 110 and a data generator component 120. The analysis component 110 receives, retrieves, or otherwise obtains or acquires a push-based query or in other words a query over push-based data (also referred to as observable data or observable sequence). Upon receipt, the analysis component 110 can analyze the query to ensure it is in an acceptable, comprehendible form. For example, the analysis component 110 can perform syntactic and semantic analysis of the query. If there are any potential issues with the query, corresponding errors, warnings, or other messages can be output.

The data generator component 120 generates or constructs a data structure or data representation of a push-based query. By contrast, a fixed code representation could have been produced from or as a function of the push-based query to enable in-process querying of push-based data such as events (e.g., mouse movement, clicks, asynchronous computations . . . ). Here, however a data representation (a.k.a. code-as-data representation) is emitted to facilitate subsequent analysis, optimization, transformation, and/or remoting, among other things. Although not limited thereto, the functionality provided by the query transformation system 100 can be implemented within a program language compiler. In accordance with one embodiment, the push-based query can be specified within a query expression. A query expression is a shorthand query syntax that can allow declarative rather than imperative specification of a query (e.g., what rather than how). Furthermore, a query expression can be integrated within a program language (Language Integrated Query (LINQ)) as a first-class construct subject to type checking, among other things. In any event, a query expression provides a high level and convenient manner of query specification, which can be transformed to, and implemented on top of, lower-level language constructs or primitives. For example, query operators associated with various families of operations (e.g., filtering, projection, joining, grouping, ordering . . . ) can be provided, such as but not limited to “where” and “select” that map to methods that implement the operators that these names represent, for instance. Regardless of particular implementation, a user can specify a query such as “from n in numbers where n<10 select n” wherein “numbers” is a data source and the query returns integers from the data source that are less than ten. Of course, query operators can be combined in various ways to generate queries of arbitrary complexity. Of course, query expressions are one form of expression. Other forms of expression can also be employed such as any query syntax that is translated into method calls, lambda expressions, or other constructs, for example.

In accordance with another embodiment, the data structure or data representation produced by the data generator component 120 can be an expression tree, which is an abstract syntax tree representation of code. In other words, an expression tree represents code in a tree-like data structure, where each node is an expression, such as a method call or a binary operation. In one implementation, an expression tree can be constructed by first generating expression trees associated with lambda expressions, for instance, a predicate for a “where” filter expressed in terms of a lambda expression (e.g., person=>person.Age>18). Subsequently, those expression trees can be stitched together with query operators and parameters to construct a single expression tree, as will be described further hereinafter.

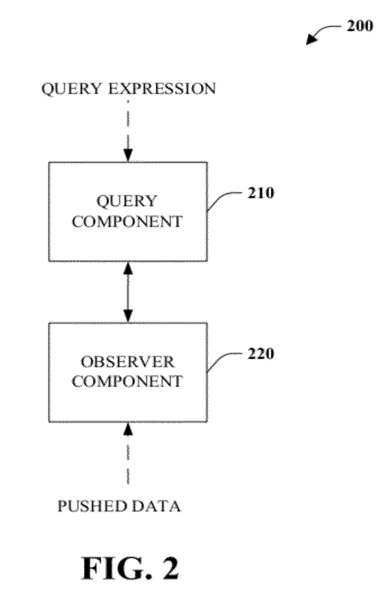

FIG. 2 illustrates a system 200 that facilitates query declaration in accordance with one embodiment. The system 200 includes a query component 210 that can provide a plurality of query operators to aid declarative specification of queries, as previously described. For example, query operators and methods implementing such operators can include but are not limited to “select,” “selectmany,” where,” “join,” “orderby,” “groupby,” “merge,” “average,” “min,” “max,” and “sum.” Moreover, these operators function over push-based data sources rather than pull-based data sources. Still further yet, the operators can be specific to a data representation of a query, and perhaps aid in construction of the data representation. In one instance, if query operators already exist for local in-process querying of push-based data (e.g., events), these operators can be extended to support operation with respect to a data representation.

The observer component 220 provides the functionality to acquire data from push-based data sources. More particularly, the observer component 220 can receive notifications regarding provisioning of data by push-based data sources including data provided thereby, among other things. Stated differently, the observer component 220 can implement an observer design pattern to receive push-based notifications regarding data.

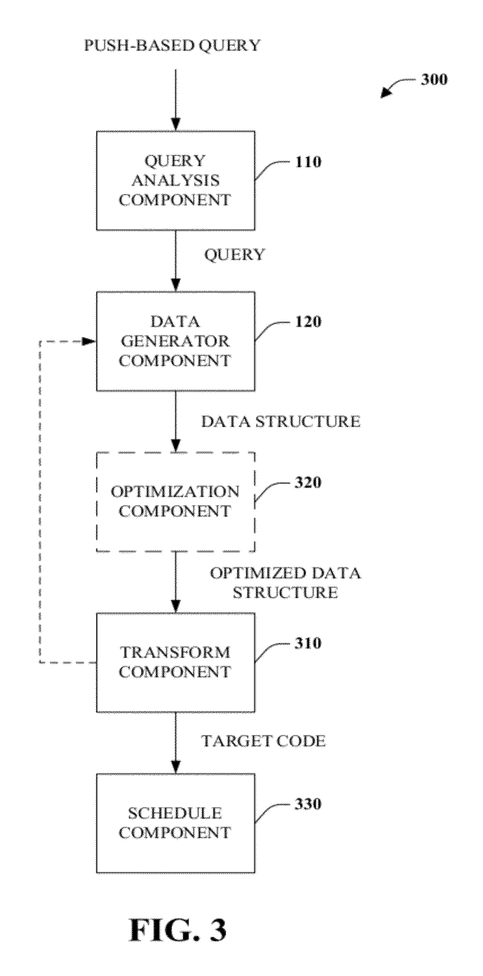

FIG. 3 illustrates a query transformation system 300. Similar to query transformation system 100 of FIG. 1, the system 300 includes the analysis component 110 and the data generator component 120. Briefly, the analysis component 110 is configured to analyze an acquired push-based query to determine if there are any issues with the query and data generator component 120 is configured to produce a data structure or data representation of a query. Further, the operation of the data generator component 120 can be influenced with knowledge of a target execution engine (e.g., out-of-process execution engine or environment) or type thereof in accordance with one embodiment. In effect, the emitted data structure or portions thereof can be parameterized by, or customized, where possible, with knowledge of who is going to process or otherwise interact with the representation of the query. This can be particularly useful with respect to constructor methods and n-ary operators (operators with n arguments) that do not have a “source” parameter or receiver object (e.g., “A”. operator) and where it is ambiguous as to who is going to execute an operation. For example, if a merge operation is to be performed across a number of queries that span multiple data sources, it is unclear as to the type generated.

To address this situation, a number of techniques can be employed. For example, a placeholder can be injected which can later be replaced with an appropriate receiver or type. In this case, a user can identify the party that will take leadership over the operation, for instance by specifying a provider (e.g., calling Merge on PowerShell Provider Object). Alternatively, a transform component 310 can be enlightened about how to deal with operators that span queries over different sources, for example by disallowing those or by using artificial intelligence or the like to infer a “leader” that will guide the translation. Yet another model would be where providers cooperatively decide who is going to take the leader based on some protocol they all implement.

Once a data representation of a query is produced, various operations can be performed easily thereon by traversing the data representation and applying operations with respect to acquired data. For example, the query transformation system 300 also includes a transform component 310 that can transform or translate the produced data structure representative of a push-based query into another form such as executable code for system or platform responsible for executing the query (e.g., Windows Management Instrumentation® (WMI), Windows PowerShell®, StreamInsight . . . ). For example, the data structure can be utilized to produce WQL (WMI Query Language), which is a subset of SQL (Structured Query Language) with a few semantic changes. Similarly, the transform component 310 could be utilized to transform a data structure into a local code or a local execution plan. For example, the data structure could be cross-compiled to generate code that binds against operators over in-process observable sequences.

The query transformation system 300 also includes an optimization component 320 that can be employed to optimize the query utilizing the data representation. For example, if upon analysis of the data structure it is observed that a query specifies “where b where q” it can be removed and replaced with “where b and q.” In another example, the optimization component 320 could exploit domain-specific knowledge of query operators to replace “orderby . . . where” with “where . . . orderby” as those operators commute, and sorting a smaller pre-filtered data set requires less work. The result produced by the optimization component 320 is an optimized data structure, which can ultimately produce an optimized translation. It should be appreciated that in some instances optimization can be thought of a specific type of translation or transformation. Furthermore, the optimization component 320 could be supplied as an independent, generic component from which some or all query provider implementations can benefit.

A schedule component 330 is a distribution mechanism that determines where code will execute and schedules the code for execution. While converting a query to a data representation allows translation into another language (e.g., SQL, WQL, CAML (Collaborative Application Markup Language) . . . ), the aspect of transmitting or in other words remoting queries to another execution environment, for example, is an orthogonal concern. In short, data structures allow translation while schedulers enable distribution. Using this principle it would be possible to write translatable queries that are location unaware and that are distributed to an execution environment using a “SubscribeOn” operator call. Consider, for example:

(from proc in wmi.ProcessStartTrace where proc.Name == “notepad.exe”
select proc.Id).SubscribeOn(...)

Here, the query translation for WMI can recognize the operator and bind the query expression against that machine using remoting application programming interfaces (APIs), for example.

In accordance with one embodiment, the functionality provided by the analysis component 110 and the data generator component 120 can be performed at compile time or in other words program development time. Conversely, the functionality provided by the transform component 310 and the optimization component 320 can be performed at run time. A data representation of a query is a convenient intermediate format that is facilitates runtime analysis, optimization, and transformation, among other things. By contrast, it would be much more difficult and time consuming to perform the same operations on a code representation. Functionality associated with scheduling can be performed at least at run time.

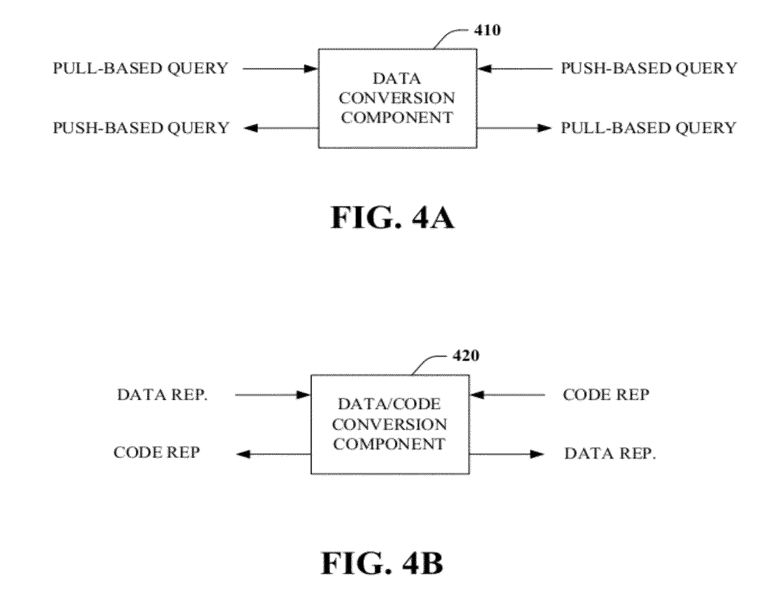

Turning attention to FIGS. 4A and 4B, conversion components 410 and 420 are provided that enable queries specified with respect to a first context to be converted to a second context. More specifically, FIG. 4A illustrates a data conversion component 410 that can receive data representations with respect to pull- or push-based queries and perform conversions between the two. In particular, if a push-based query data representation is provided, a pull-based query data representation can be returned. Likewise, if a pull-based query data representation is provided, a push-based query data representation can be supplied. FIG. 4B depicts a data/code conversion component 420. Here, given a data representation of query a code representation can be generated, for example for in-process execution. Similarly, given a code representation of a query, the data/conversion component 420 can produce data representation.

Furthermore, it should be appreciated that only a portion of a query can be converted to another form. Consider a situation in which conversion is to be performed from a code representation to a data representation. Here, select portions of the query could be excluded from data transformation. In one embodiment, these select portions can be injected into the data representation as node constants or literals that are not subject to conversion. In other words, the next stages of optimization and/or translation no longer are able to see details that have been evaluated away, for example by local evaluation of non-translatable portions.

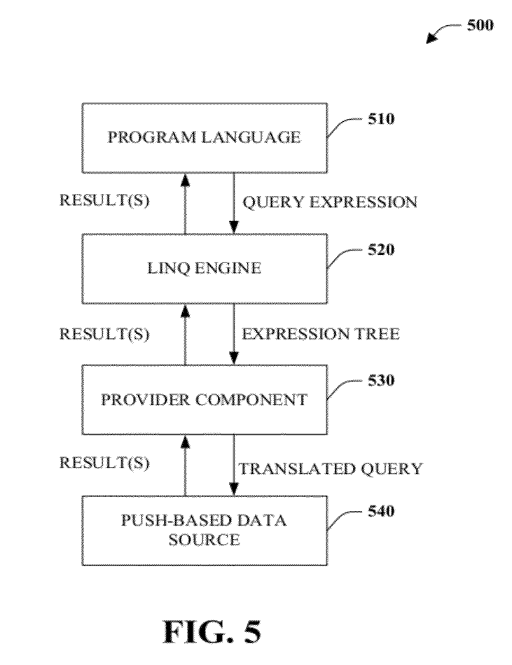

Turning attention to FIG. 5, an exemplary data access system 500 is illustrated that provides a framework within which aspects of the disclosure can be employed and additional detail provided. The data access system 500 includes a program language component 510, a language integrated query (LINQ) engine 520, a provider component 530, and a push-based data source 540. The program language component 510 provides a mechanism to specify a query expression over the push-based data source 540 amongst other programmatic functionality.

The LINQ engine 520 provides functionality to support use of query expression syntax (e.g., specification of a query expression pattern) in the program language component 510. For example, the LINQ engine 520 can specify supporting code such as methods that implement query operators with respect a push-based data source as well as code to enable generation of an expression tree as a data representation of the query, among other things.

The provider component 530 can produce a query that is comprehendible by the push-based data source 540 from the expression tree. Furthermore, the provider component 530 can generate and assist in construction of a particular object such as an IQbservable<T> object with the correct type (T) from the expression tree. Typically, “T” follows immediately from operators being used by a user, for example a projection can change the “element type” while other operators do not. What the provider component 530 has to be careful about is making sure the dynamic type (e.g., the class implementing the interface) is such that it will be able to take responsibility over executing the query expression written by the user. Furthermore, the provider component 530 can act as the entry point to expression tree forms of various operators that do not have a suitable left-hand side source parameter including constructor methods as well as n-ary operators such as “Merge” and “Amb” (Ambiguous as to what is returned). Furthermore, the query provider can act as an entry point for an “And” operator/method and the exit point for a “Join” operator/method, for example. Thus, enabling complex joins to be employed, further details are provided later herein. Moreover, any domain-specific language that expresses query constructs could be captured and embedded in a bigger data representation of a whole query.

Upon receipt of an appropriate query, the push-based data source 540 can return results that satisfy the query. Such results can then be pushed back to the program language component 510 or more specifically an executing program specified with the program language component 510.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the analysis component 110 can employ such mechanism to infer types and otherwise analyze queries. Furthermore, such mechanisms can also be employed to aid in optimizing a data representation of a query as well as scheduling, among other things.

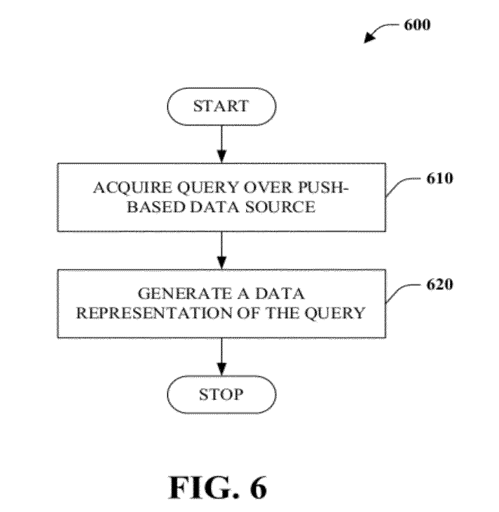

In view of the exemplary systems described supra, methodologies that may be implemented in accordance with the disclosed subject matter will be better appreciated with reference to the flow charts of FIGS. 6-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 6, a method 600 of query transformation is illustrated. At reference numeral 610, a query over a push-based data store or in other words a push-based query is received, retrieved or otherwise obtained or acquired. In one implementation, the query can be specified as a query expression—a simple, declarative syntax that can be integrated within a programming language (e.g., language-integrated query (LINQ)). At reference 610, a data representation of the query is constructed. For example, an expression tree can be produced that captures inline code input to query operators in combination with query operators and operator parameters (e.g., source parameters). Furthermore and although not shown, the received query could be analyzed to ensure it is in an appropriate form prior to construction of the data representation. However, such analysis can additionally or alternatively be provided utilizing the data representation.

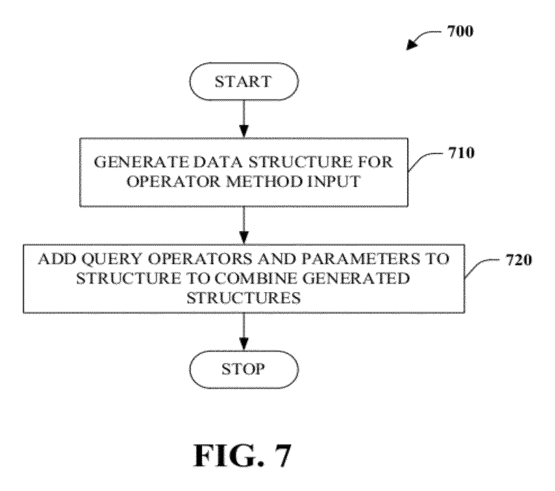

FIG. 7 is a flow chart diagram of a method 700 of generating a data representation of a push-based query. At reference numeral 710, a data structure is created to capture input to query operators, for example as lambda expressions. At reference 720, query operators and source parameters (e.g., first parameters to left of operators) are added to the structure in combination with previously generated structures to produce a data structure representing the push-based query. Stitching together structures can be performed from left to right corresponding to a method-call evaluation order. Of course, this is just one approach, for example, where a tree is created that represents the shape of a query in terms of method-call expressions, among other things. Alternatively, one could stitch the parts together in a domain-specific query tree, for example where different overloads of a “Where” operator turn into a “Where” query expression tree node including the filter as an expression tree. Such transformations can also be seen as a translation and one could go back and forth between such representations.

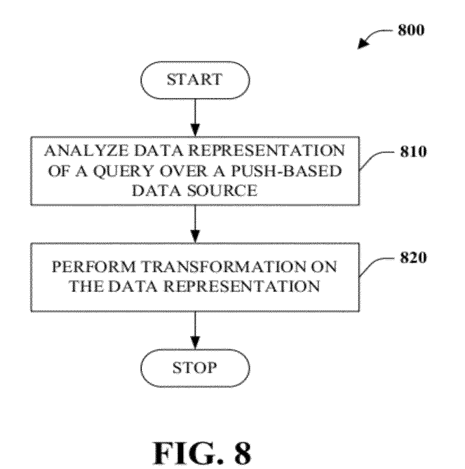

FIG. 8 depicts a method 800 for interacting with a data structure representation of a push-based query. At reference numeral 810, the data structure of a query over a push-based store is analyzed (e.g., syntactic and semantic analysis). At reference numeral 820, a transformation is performed on the data structure representation. For example, a new optimized data structure representation can be produced. Additionally or alternatively, the data structure can be utilized to produce code executable by a target system or platform. Further yet, the data structure can be transformed into a local execution plan. In essence, the data representation is an intermediate representation that allows runtime inspection, optimization, service provisioning (e.g., debugger, tracing services) over local queries. The data structure can also be transformed into locally executable code (e.g., intermediate language code) that binds against corresponding query operators (code operators).

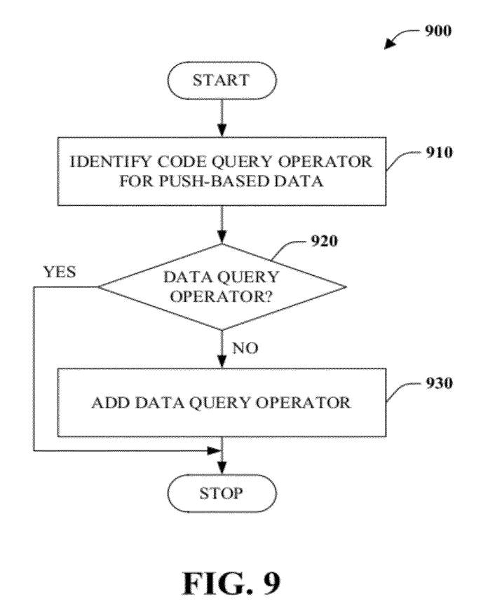

FIG. 9 is a flow chart diagram of a method 900 of maintaining code parity between data and code operations over push-based data. At numeral 910, a code query operator for push-based queries is identified. At reference 920, a determination is made as to whether or not there is a corresponding data query operator for push-based queries. If there is a data query operator (“YES”), the method simply terminates. If there is not a corresponding data operator (“NO”), then, at 930, such an operator is added and the method terminates. In accordance with one embodiment, adding a corresponding data operator can include copying the code operator and modifying a method signature to allow data to be produced rather than code, among other things, such as but not limited to adding parameters for operators that do not have clear source that will take the lead in performing an operation (e.g. Amb, Merge . . . ). In such a case, a parameter can be added to specify which source is the lead over a query's translation and/or execution. Other forms of instrumentation can also be employ, which may warrant automatic addition or rewriting of operator parameters. Of course, upon termination, another code query operator can be identified at 910 until all code query operators are identified and corresponding data query operators added (not shown.).

What follows is one particular implementation of at least a portion of the functionality described above including further details and concrete examples. Of course, this is not the only manner in which previously presented concepts can be embodied, and as such, the appended claims are not intended to be tacitly or implicitly limited by this implementation.

Query expression syntax enabled through modern programming languages such as C#® and Visual Basic® is a form of syntax-directed translation into lower level primitives of a language such as method calls and lambda expressions. The latter of those supports two supports forms, one of which is regular delegates such as: “Fun<int, int, int>f=(a, b)=>a+b.” In this sample code snippet, the lambda expression “(a, b)=>a+b” can be transformed into an anonymous method that can readily be invoked as executable code. In other words, the lambda expression is turned into a method with the lambda expression's parameters and instructions that correspond directly to the lambda body. For example, “int three=f(1, 2).”

On the other hand, when a lambda expression is assigned to an Expression<TDelegate> type, the compiler can turn it into an expression tree that can be inspected at runtime to decipher user intent. For example:

Expression<Fun<int, int, int>>f=(a, b)=>a+b.
This corresponds to a data representation of code, or in other words a code as data representation, which enables various interpretations and transformations to be performed at run time. The above code roughly corresponds to the following data representation:

ParameterExpression a, b; /* code to initialize those omitted */
Expression <Func<int, int, int>> f =
Expression.Lambda<Func<int, int, int>>(Expression.Add(a, b), a, b);

Query expressions can exploit this property of homo-iconicity (where one can write one representation using a single syntax but actually get one or more representations back) for lambda expressions in order to provide a common syntax that can be used for both “local” and “remote” queries. Though this is commonly used as the vocabulary for different kinds of queries, it is better to distinguish the two based on their representation form, decoupled from distribution properties. When a query is represented as data using expression trees, for example, it can be analyzed, optimized, and/or translated at runtime, possibly to execute on a remote machine like a database engine, but not necessarily.

One way query expressions can be translated is by emitting a chain of method calls that correspond one-by-one to the query operators, passing in lambda expressions where needed. Consider the following query expression:

from x is xs where x % 2==0 select x+1
This query expression is turned into the following equivalent piece of code. Notice the appearance of lambda expressions, which will be turned into either local delegates or expression trees depending on the signature of the query operators.
xs.Where(x=>x % 2==0).Select(x=>x+1)
For both the “IEnumerable<T>” and “IObservable<T>” interfaces, query operators like the ones used above (e.g., Where, Select) can be defined as extension methods in classes “Enumerable” and “Observable,” but defined to be applied to objects of the “IEnumerable” or “IObservable” interfaces. Signatures of those operators take in regular “Func< . . . >” delegates for the lambda expression parameters. For example:

static class Observable
{

public static IObservable<T> Where<T>(this IObservable<T>

source, Func<T, bool> filter) {...}

public static IObservable<T> Select<T, R> (this IObservable<T>

source, Func<T, R> selector) {...}
...
}

This implementation of those operators realizes “verbatim execution” based on code (e.g., IL code) typically within the same application domain as the place where the query expression was written. In particular, upon subscription to the resulting query expression, calls to the various lambda expressions can be triggered, which execute literally. At no point does the implementation of the operators inspect the shape of the global query as a data structure.

In order to enable the same query expression, with no change of syntax, to be processed by another query processor, expression tree facilities can be utilized. Examples of such use include SQL databases for enumerable queries and WQL WMI event providers for observable queries. Use of a common query syntax provides several benefits for end-users such as not having to learn different query languages, static typing of the query, compile-time checking, and developer tool support for automatic code completion, among other things.

By way of example, consider the following query expression:

from proc in wmi.ProcessStartTraces where proc.Name == “notepad.exe”
select proc

Assuming the “wmi.ProcessStartTraces” collection is provided by a so-called query provider that bridges with the WMI infrastructure in the Windows® operating system, the query expression can be turned into the following WQL code:

SELECT * FROM Win32_ProcessStartTrace WHERE ProcessName =
“notepad.exe”

In the query expression shown above, the “ProcessStartTraces” collection is typed as a generic collection that uses the “entity type” definition for its element type:

class WmiProvider
{

public WmiSource<ProcessStartTrace> ProcessStartTraces { get; }

}

The “WMISource<T>” type is not only an IObservable<T> such that subscription to the resulting event stream can be achieved by means of the “Subscribe” method, but it is also more specialized. In particular, it implements a new interface IQbservable<T> that is used to provide a query over observable data sources represented using expression trees:

interface IQbservable<out T> : IObservable<T>
{

IQbservableProvider Provider { get; }
Type ElementType { get; }
Expression Expression { get; }

}

Since IQbservable<T> is a more specific interface than IObservable<T>, its extension methods (defined in the Qbservable class) will take precedence over the extension methods defined for IObservable<T>. The difference for the IQbservable<T> query operators lies in the parts of the signature involving lambda expressions:

static class Qbservable
{

public static IQbservable<T> Where<T>(this IQbservable<T> source,

Expression<Func<T, bool>> filter) { ... }

public static IQbservable<R> Select<T, R>(this IQbservable<T>

source, Expression<Func<T, R>> selector) { ... }

...

}

Even though a user writes a query expression in a familiar syntax, use of various operators now triggers calls to the query operator methods shown above (e.g. homo-iconicity). Since a lambda expression is assigned to the “Expression< . . . >” parameters, an associated compiler can synthesize an expression tree representation of them that is passed to the methods shown above.

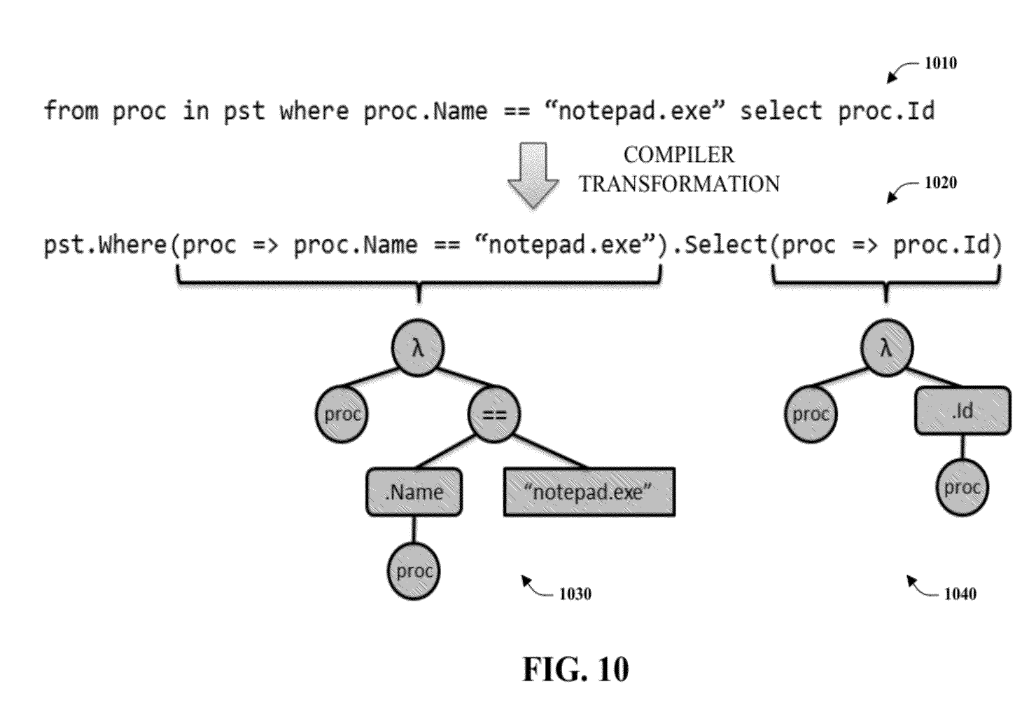

FIG. 10 illustrates a first phase of compilation in which query expressions trigger emission of expression trees for lambda expressions due to assignment. In particular, a query expression 1010 is transformed into a code 1020 including lambda expressions assigned as parameters to query operator methods. Since these lambda expressions are assigned to “Expression< . . . >” parameters, the lambda expression are transformed into expression trees 1030 and 1040.

Next, the functional fragments of a query expression can be observed such as filter or selector expressions. In order to generate a complete expression tree representation of a entire query expression, the query operator methods (which can be defined by a provided framework rather than individual query providers) can stitch together expression trees as follows:

public static IQbservable<T> Where<T>(this IQbservable<T> source,
Expression<Func<T, bool>> filter)
{

return source.Provider.CreateQuery<T>(

Expression.Call(

((MethodInfo)MethodInfo.GetCurrentMethod( )).
MakeGenericMethod(new[ ] { typeof(T) }),
source.Expression,
filter

)

);

}

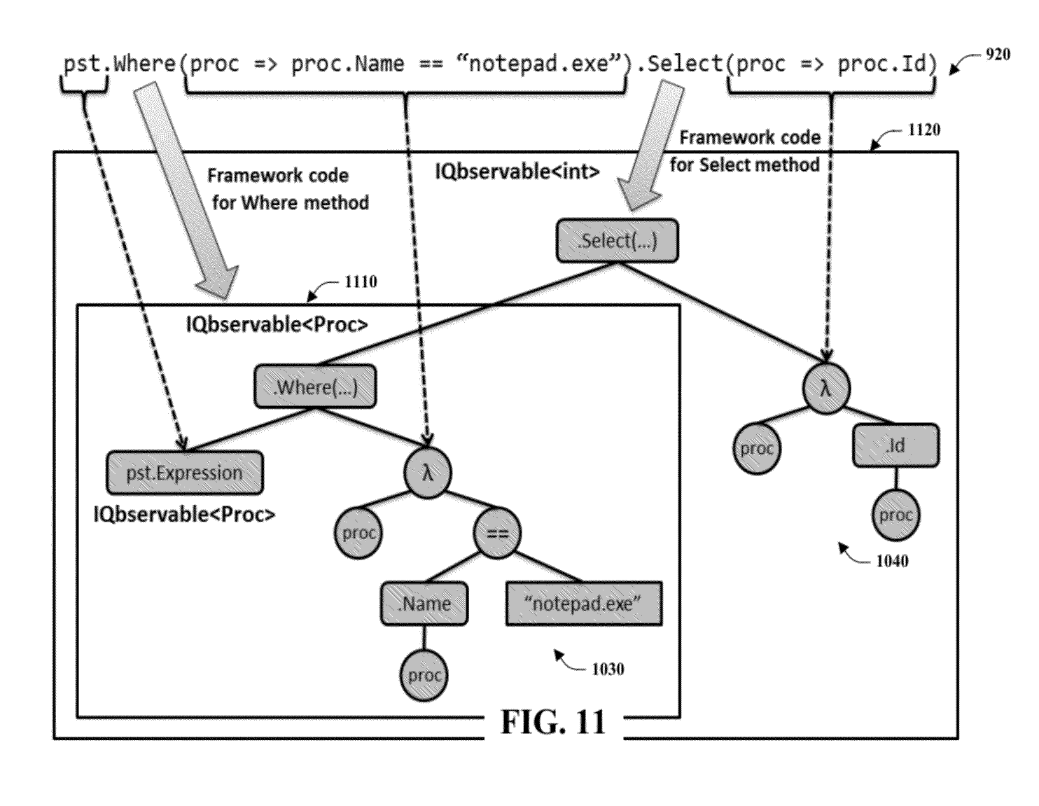

FIG. 11 illustrates a second phase of compilation wherein expression tree stitching is carried out by query operators. For each call to a query operator, the left-hand side's (first parameter's) expression is extracted from the given IQbservable<T> source object. This expression represents the query expression captured so far (in a left-to-right manner, corresponding to method-call evaluation order). Once this happens, the expression is wrapped in a bigger expression tree that puts the method call to the query operator on top of it while also passing in the fragment(s) passed in by the compiler as an effect of lambda expression assignment to the “Expression< . . . >” parameter(s). As shown moving from left to right, a first expression tree 1110 is generated for the “where” operator comprising “pst” as a source parameter and the previously generated expression tree 1030 for the lambda expression. Subsequently, the expression tree 1110 forms the left hand side of the larger expression tree 1120 corresponding to the “select” operator, which also includes previously generated expression tree 1040 corresponding to a lambda expression on the right-hand side. The resulting expression tree 1120 can now be handed to a query provider.

The role of a query provider is twofold. First, it helps in constructing IQbservable<T> objects of the correct dynamic type, and second it can act as the left-hand side for certain query operators that do not have an obvious “source” parameter. An exemplary signature for a query provider follows:

interface IQbservableProvider
{

public IQbservable<T> CreateQuery<T> (Expression expression);

}

In the first role, the “CreateQuery<T>” method is significant. As observed in the code fragment for the “Where” operator, the resulting stitched expression tree is fed to this method in order to create a new instance of a type implementing “IQbservable<T>.” Query providers should hand back an “IQbservable<T>” object that will properly respond to a “Subscribe” method, at which point the query expression tree should be analyzed and enabled for execution. In other words, the “CreateQuery” method is a factory method that enables a generic implementation of the stitching query operator methods that loops in the help of a query provider to create the correct resulting “IQbservable<T>” instance. Since an interface is an abstract type, provider assistance can be added to construct the right dynamic type of an object. An example of the implementation of “IQbservable<T>” and “IQbservableProvider” is shown below for WMI:

class WmiSource<T> : IQbservable<T>
{

public WmiSource( )
{

Expression = Expression.Constant(this);

// Will represent the source itself; connection strings
//etc. could be kept on the object.

}
internal WmiSource(Expression expression)
{

Expression = expression;

// Called by the query provider in response to an
//operator call.

}
public Expression Expression { get; private set; }
public Type ElementType { get { return typeof(T); } }
public IQbservableProvider Provider { get { return new

WmiProvider( ); } }
public IDisposable Subscribe(IObserver<T> observer)

{
//Take the expression tree in Expression and translate it to WQL.
}

}
class WmiProvider : IQbservableProvider
{

public WmiSource<T> CreateQuery<T> (Expression expression)
{

// This is called by the Qbservable operator methods,
//asking to wrap the tree in an IQbservable. This will also
//take responsibility for subscribing to (e.g. by cross-
//translation into another language, like WQL).

return new WmiSource<T>(expression);

}

}

Notice the “ElementType” on “IQbservable<T>” seems trivial but provides a means for query expression translators to acquire the element type without heavily relying on reflection APIs.

The second role of the “IQbservableProvider” interface is to act as the entry point to expression tree forms of various operator that do not have a suitable left-hand side “source” parameter to construct queries through. Examples include constructor methods as well as n-ary operators such as “Amb:”

class Qbservable
{

public IQbservable<T> Return<T>(this IQbservableProvider

provider, T value)

{

return provider.CreateQuery<T>;

//code representing this method call with its arguments

}
public IQbservable<T> Amb<T>(this IQbservableProvider provider,

params IObservable<T>[ ] sources)

{

return provider.CreateQuery<T>;

//code representing this method call with its arguments

}
...

}

Notice the “Amb” operator takes in an array of “IObservable<T>” sequences, rather than “IQbservable<T>” sequences. This enables the execution of “Amb” between “local” (verbatim) and “remote” (interpretable) sequences. It is up to the provider to figure out whether this operation can be realized, for example by requiring all sequences to be “IQbservable” with the same provider, or by transmitting certain sequences to another tier where they can be subject to the same “Amb” operation. Alternatively, a generic query provider implementation could be used here that does the decision making as to who will process the operation over the supplied data sources (e.g., an arbiter provider that uses a set of rules to make decisions).

Besides the expression form for regular query operators, join patterns can also be expressed as such. This allows complex join logic between sequences to be remoted, analyzed, or optimized as well. To facilitate this, the “System.Joins” namespace has homo-iconic forms to “Pattern” and “Plan,” with a “Queryable” prefix:

abstract class QueryablePattern
{

public Expression Expression { get; }

}
class QueryablePattern<T1, T2> : QueryablePattern
{

public QueryablePattern<T1, T2, T3> And<T3>(IObservable<T3>

other);

public QueryablePlan<TResult>
Then<TResult>(Expression<Func<T1,

T2, TResult>> selector);
}
class QueryablePlan<TResult>
{

public Expression Expression { get; }

}

Query providers need not be involved in the declaration of a queryable pattern and plan. Rather, the entry-point “And” method and the exit-point “Join” method use a provider to establish a connection with a provider for execution of the expression at a later stage:

public static QueryablePattern<TLeft, TRight> And<TLeft, TRight>(this
IQbservable<TLeft> left, IObservable<TRight> right);
public static IQbservable<TResult> Join<TResult>(this
IQbservableProvider provider, params QueryablePlan<TResult>[ ] plans);

Notice how only a minimum number of parameters is turned into “IQbservable,” as to retain a maximum level of flexibility where a mix of “verbatim” and “interpretable” sequences can be combined. Upon inspection of the expression trees, the translator or transform component 310 can perform type checks among other things to determine whether a verbatim or data representation of parameters is employed (e.g. “And” between a “local” and “remote source, where the former would be detected since it will only implement IObservable<T> while the latter will implement IQbservable<T>)

One query provider for observable sequences can be supplied, which turns an expression tree based query expression into the corresponding local execution plan using the Observable methods. In essence, it is a means to do runtime inspection, optimization, service provisioning (e.g. debugger or tracing services) over “local” queries by exposing the expression tree as an intermediate representation. Upon subscription, the resulting expression tree is cross-compiled into IL code that binds against the Observable operators. For example:

### Observable.Provider.Return(5)

Here, the Provider get-only property exposes the “local queryable observable” provider. Another way to enter the world of expression trees over local queries is to use the AsQbservable operator:

### Observable.Range(0, 10).AsQbservable( ).Where( . . . ) . . .

In this sample, the “Observable.Range(0, 10)” part is captured as an opaque node in an expression tree that is not amendable to easy introspection but every operator call after the “AsQbservable” call amendable to easy introspection. In other words, it is difficult for a tree inspector to see the user wrote “Range” and what its parameters to that call were. In fact, an expression tree is constructed that captures “Observable.Range(0, 10)” as an opaque node in the expression tree, followed by query operator calls in expression tree format. The property of “being expression tree based” is contagiously carried forward through further operator calls, such that the result of the above remains an “IQbservable” whose expression tree exposed the whole query expression. To leave the world of “IQbservable,” one can either call Subscribe or use “AsObservable.” The latter operator is implemented in a very straightforward manner and simply realizes a cast:

public static IObservable<T> AsObservable<T>(this IQbservable<T>

source)

{

return this;

}

As a result of calling this operator, the static type of the return type will guide the compiler to choose extension methods on “Observable” rather than “Qbservable.” Since those methods ultimately trigger a call to “Subscribe” on their source argument, the effect with regards to leaving the “IQbservable” world in favor of “IObservable” is pretty much the same as calling “Subscribe” directly. The “Subscribe” method performs the cross-translation (at runtime) into “Observable” query operators:

### Observable.Range(0, 10).AsQbservable( ).Where( . . . ) . . . .AsObservable( ).Where( . . . ) . . .

In the sample above, the call to “AsObservable” will effectively restore the qbservable-free query:

Observable.Range(0, 10).Where( . . . ) . . . .Where( . . . ) . . .

This round tripping is useful when the intermediate expressions are analyzed through the “Expression” property. They also enable things like serialization of wholesale query expressions between different tiers, assuming the presence of a serialization mechanism for expression trees and generic optimization over various queries.

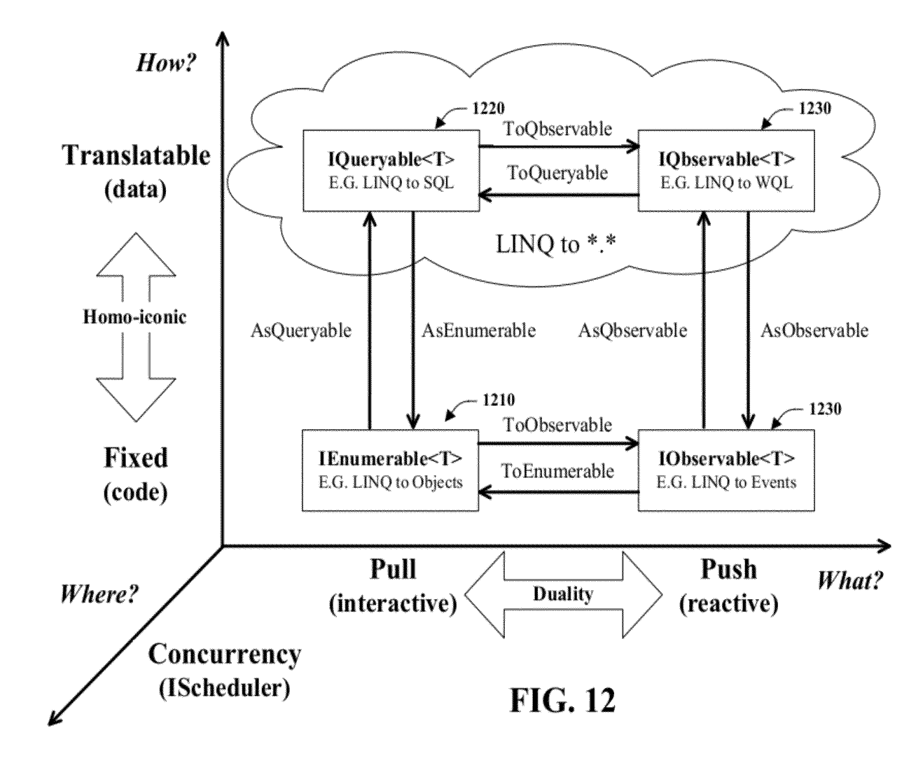

FIG. 12 is a graphical illustration of the relationship between four collection interfaces to aid clarity and understanding with respect to aspects of this disclosure. As shown, IEnumerable<T> interface 1210 resides in the lower right corner of the illustration indicative of the fact that the IEnumerable<T> interface operates with respect to pull-based data utilizing a fixed code representation. More specifically, IEnumerable<T> interface 1210 exposes an enumerator that supports iteration over a collection of a specified type. For example, one can iterate over in-memory objects. IQueryable<T> interface 1220 also operates over pull-based data and, in fact, implements the IEnumerable<T> interface 1210. Accordingly, everything that can be done with respect to an IEnumerable<T> can also be done with respect to an IQueryable<T>. The primary difference is that IEnumerable<T> works for in-memory sequences while IQueryable<T> works with respect to out of memory sequences. In other words, where execution of a query is going to be performed in-process, all that is needed is the code to execute each part of the query. By contrast, where execution will be performed out-of-process, the logic of the query should be represented as data such that a query provider can transform the query into an appropriate form for out-of-memory execution (or execution with respect to a target execution environment or engine). For example, a query can be transformed to SQL for execution by a relational database.

IObservable<T> interface 1230 and IQbservable<T> interface 1240 are mathematical duals of IEnumerable<T> interface 1210 and IQueryable<T> interface 1220. As shown graphically, one significant difference between the interfaces is that IObservable<T> interface 1230 and IQbservable<T> interface 1240 operate over push-based data sources whereas IEnumerable<T> interface 1210 and IQueryable<T> operate with respect to pull-based data sources. The IObservable<T> interface 1230 exposes an observer (IObserver<T>) that subscribes to an IObservable<T> and receives notifications regarding current data, changed data, or fresh data, among other things. In other words, the IObservable<T> interface 1230 represents a class that sends notifications (Provider) and IObserver<T> represents the class that receives them (Observer). Here, however, queries are represented as code and operate over in-process data such as events (e.g., mouse moves, clicks . . . ) The IQbservable<T> interface 1240 implements IObservable<T>, but operates with respect to out-of-process push-based data. To enable this functionality, a query is represented as data, such as an expression tree, which is translatable to another form such as WQL.

It is also to be noted with respect to FIG. 12, that various conversion can be performed between interfaces. For instance, an IObservable<T> interface 1230 can be transformed to an IQbservable<T> interface 1240 and vice versa. Further, distribution (Where?) can be decoupled from a query representation (e.g., code or data). For example, execution can be performed on a pool of threads, message loops, or on a cluster of machines. Utilizing, IScheduler<T> one can designate where execution will take place. For example, “ExecuteOn( . . . ),” where a computer name can be passed in to identify where execution is to occur.

As used herein, the terms “component,” “system,” and “engine” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The term “in-process” is intended to refer to code that operates together in the same process. For example, an executable program that runs as a service with respect another program rather than as a standalone program can be referred to as an in-process program. By contrast “out-of-process” refers to code that executes independent of other code. For instance, code that executes on a different machine or process than other code can be referred to as out-of-process. As used herein, the terms “in-process” and “out-of-process” are utilized to distinguish between queries that transformed into code and queries that are transformed into data.

As used herein, the verb forms of the term “remote” such as “remoting” and “remoted” are intended to refer to transmission of code or data across application domains that isolate software applications physically and/or logically so they do not affect each other. The subject of remoting (e.g., code or data) can reside on the same computer or different network connected computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

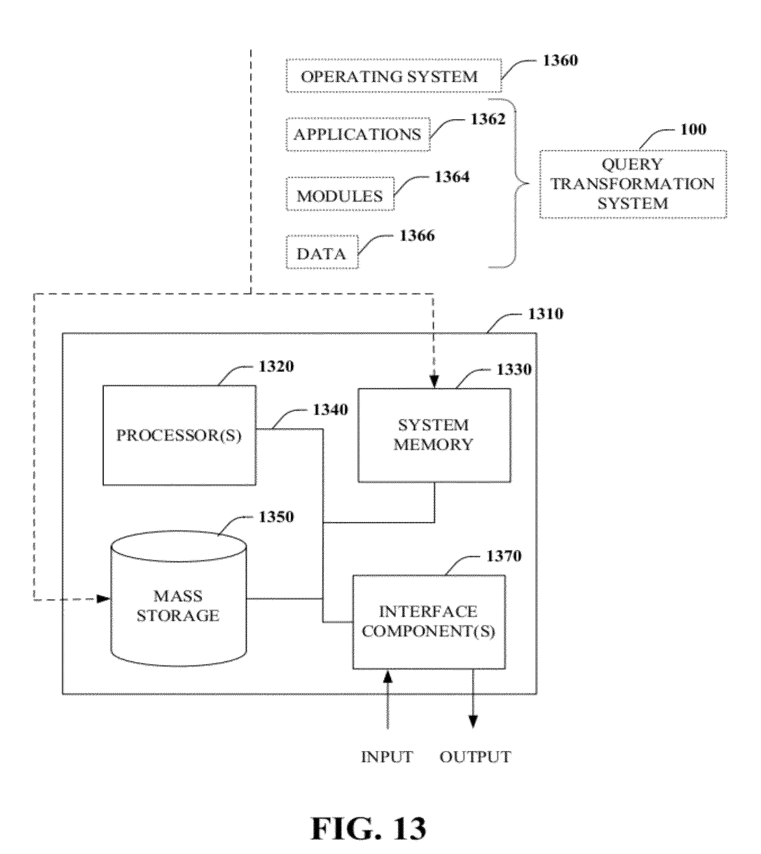

In order to provide a context for the claimed subject matter, FIG. 13 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 13, illustrated is an example computer or computing device 1310 (e.g., desktop, laptop, server, hand-held, programmable consumer or industrial electronics, set-top box, game system . . . ). The computer 1310 includes one or more processor(s) 1320, system memory 1330, system bus 1340, mass storage 1350, and one or more interface components 1370. The system bus 1340 communicatively couples at least the above system components. However, it is to be appreciated that in its simplest form the computer 1310 can include one or more processors 1320 coupled to system memory 1330 that execute various computer executable actions, instructions, and or components.

The processor(s) 1320 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1320 may also be implemented as a combination of computing devices, for example a combination of a DSP and a microprocessor, a plurality of microprocessors, multi-core processors, one or more microprocessors in conjunction with a DSP core, or any other such configuration.

The computer 1310 can include or otherwise interact with a variety of computer-readable media to facilitate control of the computer 1310 to implement one or more aspects of the claimed subject matter. The computer-readable media can be any available media that can be accessed by the computer 1310 and includes volatile and nonvolatile media and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 1310.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

System memory 1330 and mass storage 1350 are examples of computer-readable storage media. Depending on the exact configuration and type of computing device, system memory 1330 may be volatile (e.g., RAM), non-volatile (e.g., ROM, flash memory . . . ) or some combination of the two. By way of example, the basic input/output system (BIOS), including basic routines to transfer information between elements within the computer 1310, such as during start-up, can be stored in nonvolatile memory, while volatile memory can act as external cache memory to facilitate processing by the processor(s) 1320, among other things.

Mass storage 1350 includes removable/non-removable, volatile/non-volatile computer storage media for storage of large amounts of data relative to the system memory 1330. For example, mass storage 1350 includes, but is not limited to, one or more devices such as a magnetic or optical disk drive, floppy disk drive, flash memory, solid-state drive, or memory stick.

System memory 1330 and mass storage 1350 can include, or have stored therein, operating system 1360, one or more applications 1362, one or more program modules 1364, and data 1366. The operating system 1360 acts to control and allocate resources of the computer 1310. Applications 1362 include one or both of system and application software and can exploit management of resources by the operating system 1360 through program modules 1364 and data 1366 stored in system memory 1330 and/or mass storage 1350 to perform one or more actions. Accordingly, applications 1362 can turn a general-purpose computer 1310 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the query transformation system 100 can be an application 1362 or part of an application 1362, and include one or more modules 1364 and data 1366 stored in memory and/or mass storage 1350 whose functionality can be realized when executed by one or more processor(s) 1320, as shown.

The computer 1310 also includes one or more interface components 1370 that are communicatively coupled to the system bus 1340 and facilitate interaction with the computer 1310. By way of example, the interface component 1370 can be a port (e.g., serial, parallel, PCMCIA, USB, FireWire . . . ) or an interface card (e.g., sound, video . . . ) or the like. In one example implementation, the interface component 1370 can be embodied as a user input/output interface to enable a user to enter commands and information into the computer 1310 through one or more input devices (e.g., pointing device such as a mouse, trackball, stylus, touch pad, keyboard, microphone, joystick, game pad, satellite dish, scanner, camera, other computer . . . ). In another example implementation, the interface component 1370 can be embodied as an output peripheral interface to supply output to displays (e.g., CRT, LCD, plasma . . . ), speakers, printers, and/or other computers, among other things. Still further yet, the interface component 1370 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of facilitating querying data sources, comprising:
employing at least one processor configured to execute computer-executable instructions stored in memory to perform the following act:
constructing a data representation of a push-based query.

2. The method of claim 1, further comprises generating a code representation of the query from the data representation.

3. The method of claim 2, further comprises initiating transmission of the code representation to an out-of-process execution engine.

4. The method of claim 1, further comprises optimizing the query utilizing the data representation.

5. The method of claim 1, further comprises constructing the data representation based on a code representation of the query.

6. The method of claim 1, further comprises producing a data representation of a pull-based query based on the data representation of the push-based query.

7. The method of claim 1, further comprises constructing the data representation of the push-based query as a function of a data representation of a pull-based query.

8. The method of claim 1, further comprise constructing the data representation as a function of a target execution environment.

9. A system that facilitates query declaration and transformation, comprising:
a processor coupled to a memory, the processor configured to execute the following computer-executable components stored in the memory:
a first component configured to produce a data representation of a query over at least one push-based data source.

10. The system of claim 9, further comprises a second component configured to generate a code representation based on the data representation.

11. The system of claim 9, further comprises a third component configured to initiate distribution of the code representation to an execution engine.

12. The system of claim 9, the first component is configured to produce the data representation from a data representation of a query over a pull-based data source.

13. The system of claim 9, the first component is configured to produce the data representation from a code representation of a query over a push-based data source.

14. The system of claim 9, the data representation is produced as a function of a target execution engine.

15. The system of claim 9, the data representation includes an n-ary operator.

16. The system of claim 9, the data representation includes a join pattern.

17. A computer-readable medium having instructions stored thereon that perform the following acts when executed:
transforming a program-language integrated query expression that specifies a query over one or more push-based data sources into an expression tree representation.

18. The computer-readable medium of claim 17, further comprising transforming the expression tree representation of the query expression into a code representation.

19. The computer-readable medium of claim 17, further comprising transforming the expression tree representation of the query over one or more push-based data sources into an expression tree representation of the query over one or more pull-based data sources.

20. The computer-readable medium of claim 17, further comprising transforming a code representation of the query expression into the expression tree representation.
